(19) United States
(12) Patent Application Publication
(10) Pub. No.: US 2019/0303828 A1
(43) Pub. Date: Oct. 3, 2019

(54) DEVICE FOR NEGOTIATING AN OPTIMIZED RESOURCE ALLOCATION

(71) Applicant: VALORBEC, SOCIÉTÉ EN COMMANDITE, Montreal (CA)

(72) Inventors: Hamid Reza NABATI YAZDI ZADEH, MONTREAL (CA); Jia Yuan YU, MONTREAL (CA)

(21) Appl. No.: 15/941,079

(22) Filed: Mar. 30, 2018

(51) Int. Cl. G06Q 10/06

(52) U.S. Cl. CPC G06Q 10/06315; H04L 67/12

(57) ABSTRACT

A device for negotiating with a remote resource allocation server, an optimized resource allocation, comprises an input for entering a value of required resource and a time period for receiving the required resource and a processor for generating a utility function for the required resource and time period, generating a resource allocation request based on the utility function, sending the resource allocation request to the remote resource allocation server, receiving a capacity status notification for the required resource from the remote resource allocation server, generating an updated resource allocation request based on: the utility function, an Additive Increase Multiplicative Decrease (AIMD) algorithm and the required resource capacity status and iteratively repeating sending the updated resource allocation request and receiving the required resource capacity status from the remote resource allocation server and generating the updated resource allocation request until the updated resource allocation request converges with the optimal allocation.

### FIELD OF THE INVENTION

The present invention generally relates to allocation of a limited resource amongst a number of devices and in particular to a device for negotiating and optimizing resource allocation without compromising privacy.

### BACKGROUND ART

We live in a finite world where every resource, be it water, minerals, energy, bandwidth etc., is limited. As a consequence, there is a competition for allocation of resources. It is therefore desirable to regulate allocation of resources. However, a goal of any regulated allocation should be to maximize overall satisfaction or benefit, at a global level.

A utility function is a mathematical representation of an actual benefit for a span of resource allocation. A conventional approach for resource allocation, also known as a centralized approach, involves every user providing their utility functions to a central resource allocation system, which calculates resource allocation to each user on basis of all the collected utility functions. However, the centralized approach suffers from privacy issues due to disclosure of the utility function by the user. There are also other issues that arise from the centralized approach. Amongst them, the central resource allocation system must be powerful enough to concurrently calculate resource allocation to each user on basis of their collected utility functions, which limits scalability of the centralized approach. Another problem of the central resource allocation system lies in the volume of exchanges and communications between the users and the centralized resource allocation system, again seriously affecting scalability. Additionally, since the centralized approach is woven around the central resource allocation system, any failure or default on the part of the centralized resource allocation system may result in collapse of the resource allocation, thereby leaving the users without any resource.

In light of the discussion above, there is need for a device for negotiating an optimized resource allocation without compromising privacy of a user demanding a share of the resource.

Any discussion of the background art throughout the specification should in no way be considered as an admission that such background art is prior art nor that such background art is widely known or forms part of the common general knowledge in the field.

### SUMMARY OF THE INVENTION

According to a first aspect of the present invention, there is provided a device for negotiating with a remote resource allocation server an optimized resource allocation, the device comprising an input for entering a required resource and a time period for receiving the required resource, a communication unit for communicating with the remote resource allocation server and a processor for generating a utility function for the required resource and time period, the generated utility function being one of the following: an increasing concave utility function, a quasi-concave utility function or a non-monotonic concave utility function, the utility function further defining an optimal allocation for the required resource, generating a resource allocation request based on the utility function, sending the resource allocation request through the communication unit to the remote resource allocation server, receiving through the communication unit a capacity status notification for the required resource from the remote resource allocation server, generating an updated resource allocation request based on: the utility function, an Additive Increase Multiplicative Decrease (AIMD) algorithm and the required resource capacity status and iteratively repeating sending the updated resource allocation request through the communication unit to the remote resource allocation server, receiving, through the communication unit, the required resource capacity status from the remote resource allocation server and generating the updated resource allocation request until the updated resource allocation request converges with the optimal allocation.

In one embodiment of the invention, the capacity status received is a capacity constraint indicating that the required resource is already fully allocated.

In one embodiment of the invention, the updated resource allocation request is any of the following: an increase request of the required resource, a decrease request of the required resource or a no-change request of the required resource.

In one embodiment of the invention, the updated resource allocation request is calculated by adding a growth factor to the previous resource allocation request.

In one embodiment of the invention, the updated resource allocation request is calculated by multiplying the previous resource allocation request with a drop factor.

In one embodiment of the invention, the processor calculates from a probability for the drop factor.

In one embodiment of the invention, the utility function generated by the processor is a normalized logarithmic function or Sigmoidal function.

In one embodiment of the invention, the processor further verifies that the updated resource allocation request is not greater than the optimal allocation for the required resource, and reduces, with a probability, the updated resource allocation request to the value of the optimal optical allocation if the updated resource allocation request is greater than the optimal allocation for the required resource and the capacity constraint indicates that the resource is already fully allocated.

In one embodiment of the invention, the input for entering the required resource and the time period for receiving the required resource is at least one of the following: an input port for receiving a message including the required resource and the time period for receiving the required resource from an electronic device, an input port for receiving a message including the required resource and the time period for receiving the require resource from a vehicle control system, an input port for receiving a message including the required resource and the time period for receiving the required resource from an electronic device storing a calendar; an input port for receiving a message including the required resource and the time period for receiving the required resource from an electronic device executing an application for travel, an input port for receiving a message including the required resource and the time period for receiving the required resource from an electronic device executing an application for forecasting traffic during travel, an input port for receiving a message including the required resource and the time period for receiving the required resource from a vehicle control system receiving manual entries of a user of the vehicle control system, a keyboard for entering the required resource and the time period for receiving the required resource by a user.

According to a second aspect of the present invention, there is provided an electric vehicle comprising a device for negotiating an optimized electric allocation, the device comprising an input for entering a value of required electricity and a time period for receiving the required electricity, a communication unit for communicating with a remote electric charging allocation server and a processor for generating a utility function for the required electricity and time period, the generated utility function being one of the following: a concave utility function, a quasi-concave utility function or a non-monotonic concave utility function, the utility function defining an optimal allocation for the required electricity, generating a resource allocation request based on the utility function, sending the resource allocation request through the communication unit to the remote electric charging allocation server, receiving through the communication unit an electrical capacity status from the remote electric charging server, generating an updated resource allocation request based on: the utility function, an Additive Increase Multiplicative Decrease (AIMD) algorithm and the capacity status and iteratively repeating sending the updated resource allocation request through the communication unit to the remote electric charging allocation server, receiving through the communication unit the electrical capacity status from the remote electric charging allocation server and generating the updated resource allocation request until the update resource allocation request converges with the optimal allocation.

In one embodiment of the invention, the capacity status received is a capacity constraint indicating that the electricity is already fully allocated.

In one embodiment of the invention, the updated resource allocation request is any of the following: an increase request, a decrease request or a no-change request.

In one embodiment of the invention, the updated resource allocation request is calculated by adding a growth factor to the previous updated resource allocation.

In one embodiment of the invention, the updated resource allocation request is calculated by multiplying the previous resource allocation request to a drop factor.

In one embodiment of the invention, the processor calculates from a probability for the drop factor.

In one embodiment of the invention, the utility function generated by the processor is a normalized logarithmic function.

In one embodiment of the invention, the processor further verifies that the updated resource allocation request is not greater than the optimal allocation, and reduces, with a probability, the updated resource allocation request to the value of the optimal allocation if the updated resource allocation request is greater than the optimal allocation and the capacity constraint indicates that the electricity is already fully allocated.

In one embodiment of the invention, the input for entering the value of required electricity and the time period for receiving the required electricity is at least one of the following: an input port for receiving a message including the required electricity and the time period for receiving the required electricity from an electronic device, an input port for receiving a message including the required electricity and the time period for receiving the require electricity from a vehicle control system, an input port for receiving a message including the value of required electricity and the time period for receiving the required electricity from an electronic device storing a calendar; an input port for receiving a message including the value of required electricity and the time period for receiving the required electricity from an electronic device executing an application for travel, an input port for receiving a message including the value of required electricity and the time period for receiving the required electricity from an electronic device executing an application for forecasting traffic during travel, an input port for receiving a message including the value of required electricity and the time period for receiving the required electricity from a vehicle control system of a manual entries performed by a user of the vehicle control system, a keyboard for entering the required electricity and the time period for receiving the required electricity by a user.

### BRIEF DESCRIPTION OF THE DRAWINGS

At least one example of the invention will be described with reference to the accompanying drawings, in which:

FIG. 1 illustrates an exemplary environment of devices, to which the present invention may be implemented;

FIG. 2 illustrates a portion of the environment involving a device that is configured to negotiate an optimized resource allocation with a resource allocation server, in accordance with an embodiment of the present invention;

FIG. 3 illustrates a flowchart depicting operation of the device, in accordance with an embodiment of the present invention;

FIG. 4 illustrates a plurality of utility functions, in accordance with an embodiment of the present invention;

FIG. 5 illustrates an implementation of a stochastic state dependent derivative of an AIMD algorithm, when the utility function is an increasing concave utility function, in accordance with an embodiment of the present invention;

FIG. 6 illustrates an implementation of a deterministic AIMD (DAIMD) algorithm, when the utility function is an increasing concave utility function, in accordance with an embodiment of the present invention;

FIG. 7 illustrates an implementation of a probabilistic AIMD (PAIMD) algorithm, when the utility function is a non-monotonic concave utility function, in accordance with an embodiment of the present invention;

FIGS. 8A and 8B illustrate implementations of quasi-derivatives AIMD algorithm (QAIMD), when the utility function is a quasi-concave utility function, in accordance with an embodiment of the present invention;

FIG. 9 illustrates an exemplary charging station for Electric Vehicles, in accordance with an embodiment of the present invention;

FIGS. 10A-10D illustrate results obtained from simulation of a first scenario of an example, where the DAIMD algorithm has been used in conjunction with the increasing concave utility function, for the charging station of FIG. 9;

FIGS. 11A-11C illustrate results obtained from simulation of a second scenario of the example, where the PAIMD algorithm has been used in conjunction with the non-monotonic concave utility function, for the charging station of FIG. 9; and

FIGS. 12A-12C illustrate results obtained from simulation of a third scenario of the example, where the QAIMD algorithms have been used in conjunction with the quasi-concave utility function, for the charging station of FIG. 9.

It should be noted that the same numeral represents the same or similar elements throughout the drawings.

### DETAILED DESCRIPTION OF THE EMBODIMENTS

Throughout this specification, unless the context requires otherwise, the words “comprise”, “comprises” and “comprising” will be understood to imply the inclusion of a stated step or element or group of steps or elements but not the exclusion of any other step or element or group of steps or elements.

Any one of the terms: “including” or “which includes” or “that includes” as used herein is also an open term that also means including at least the elements/features that follow the term, but not excluding others.

As used in this document, the term “AIMD algorithm” refers to a group of algorithms used for resource allocation, where, if a resource under study is not entirely allocated, each one of a number of negotiating devices generate an updated resource allocation request by adding a growth factor to a previous resource allocation request and if the resource under study is entirely allocated or over-allocated, each one of the number of devices decrease their updated resource allocation request by multiplying a drop factor to the previous resource allocation request. The growth factor is envisaged to be a positive real number and the drop factor is envisaged to be a positive real number but smaller than 1. Hence AIMD stands for Additive Increase/Multiplicative Decrease. Additionally, for the purpose of this document the term “AIMD algorithm” is envisaged to include both stochastic and non-stochastic (or deterministic) derivatives of the AIMD algorithm. The term “AIMD algorithm” is also envisaged to include variations of the AIMD algorithm in which, at least for a part of an implementation, if the resource under study is not entirely allocated, each one of number of devices increase their updated resource allocation request by multiplying an inverse of the drop factor to a previous resource allocation request and if the resource under study is entirely allocated or over-allocated, each one of the number of devices decrease their previous resource allocation request by subtracting the growth factor from the previous resource allocation request.

The present invention employs a distributed approach to achieve a global optimum in resource allocation. Optimal allocation is achieved when sum of individual utilities (or benefits) derived from individual allocations, by a finite number of requesting devices is maximized. In any case, utility (or benefit) derived is a function of an actual utility value for the resource allocated. For example, there are in total n devices competing for a resource, where total value of the resource is denoted by C. For a device i (where 1≤i≤n), let the value of resource allocated to the device be denoted by xᵢ. Let uᵢ(xᵢ) denote a utility function indicating the utility that the device derives from xᵢ. At least one objective of the present invention can be denoted by equation (1).

maximizeΣⱼ₌₁ⁿuⱼ(xⱼ), while Σⱼ₌₁ⁿ(xⱼ)≤C (1)

Of course, since the present invention utilizes a distributed approach to preserve privacy, it is envisaged that each user through a device associated with them, will calculate their utility function at their end and negotiate their individual value of required resource allocation, in accordance with the utility function, with a remote resource allocation server, without ever disclosing their individual utility function to the remote resource allocation server. To this end the present invention utilizes an approach centered around Additive Increase Multiplicative Decrease (AIMD) algorithm and non-stochastic derivatives of the AIMD algorithm. To model real life scenarios and considering other factors such as continuity and derivability, the utility functions are chosen from a group comprising increasing concave utility functions, quasi-concave utility functions and non-monotonic concave utility functions.

The present invention can be implemented for a number of scenarios and applications such as allocation of computational resources (such as bandwidth, memory, processing power and platforms etc.) in a cloud based data center, allocation of electrical power being fed by electrical grids, allocation of water from a water source such as a canal, frequency spectrum allocation in mobile networks, allocation of subsidized goods such a cooking gas run under government schemes and allocation of electrical power for a number of Electrical Vehicles (EVs) being charged simultaneously at a charging station. To further illustrate the efficiency of the present invention, the example of EVs has been elaborated with an exemplary real-life scenario.

Exemplary implementation of the present invention has been illustrated with the help of illustrations in the following discussion. However, a person skilled in the art will appreciate that many other implementations are possible for the present invention without departing from its scope.

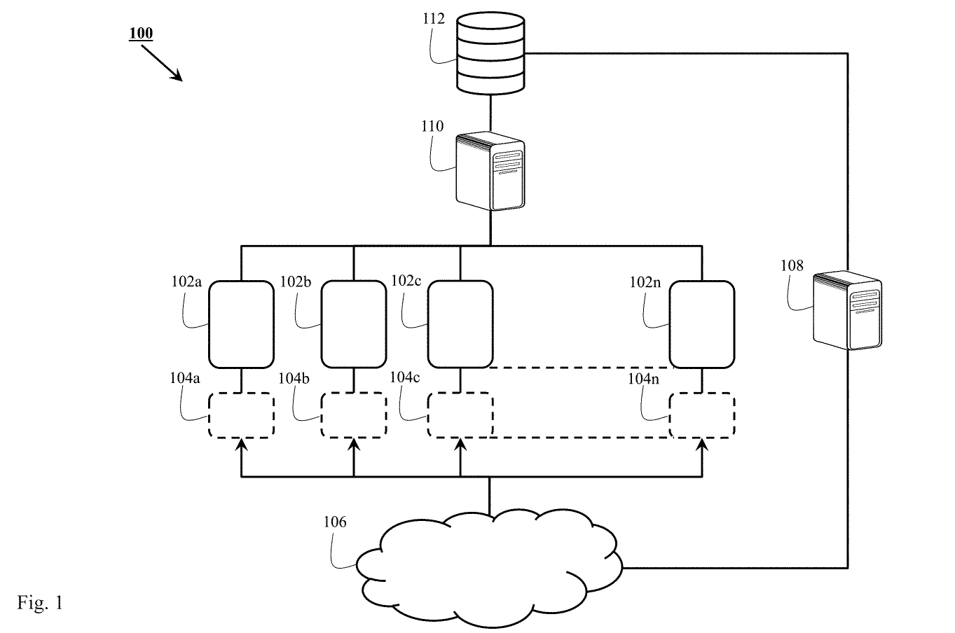

FIG. 1 illustrates an exemplary environment 100 where devices 102(i.e. 102a-102n) negotiate an optimized resource allocation. As illustrated in FIG. 1, a resource 106 needs to be allocated amongst a plurality of devices. Optionally and only if required to measure the allocated resource, connected with the resource 106, are a plurality of resource meters 104 (for example 104a, 104b, 104c, . . . 104n) that are configured to measure the allocated resource. For example, in case of a resource such as water, the resource meter 104a is a water meter or a water pump. Or in case of the resource 106 being electrical power for EVs the resource meter 104a is a charging setup installed with the EV. Each device 102 (i.e. 102a, 102b, 102c, . . . 102n) negotiates with a resource allocation server 110 the allocation of resource so as to optimize the resource allocated thereto.

When the resource 106 is charged to each device 102 on a per allocation basis, a storage device 112 stores, inter alia, values of resource allocated to each device 102 at any instant of time. The storage device 112 also stores a state of the resource 106. The state of the resource 106 may include a total value of the resource 106 (for example a total energy in kW-h), resource capabilities (for example a rate of energy transfer in kW), depletion rate, renewal rate, etc. The state of the resource 106 is monitored by a monitoring server 108 and fed to the storage device 112. All of the devices and the servers for the purpose of the invention include computing capabilities such as one or several processors (for example, general purpose processor, Field Programmable Gate Arrays (FPGA), Application Specific Integrated Circuits (ASIC) and the like) and one or several memory units, volatile (Random Access Memory (RAM) and non-volatile (EPROM, EEPROM, Flash Memory and the like).

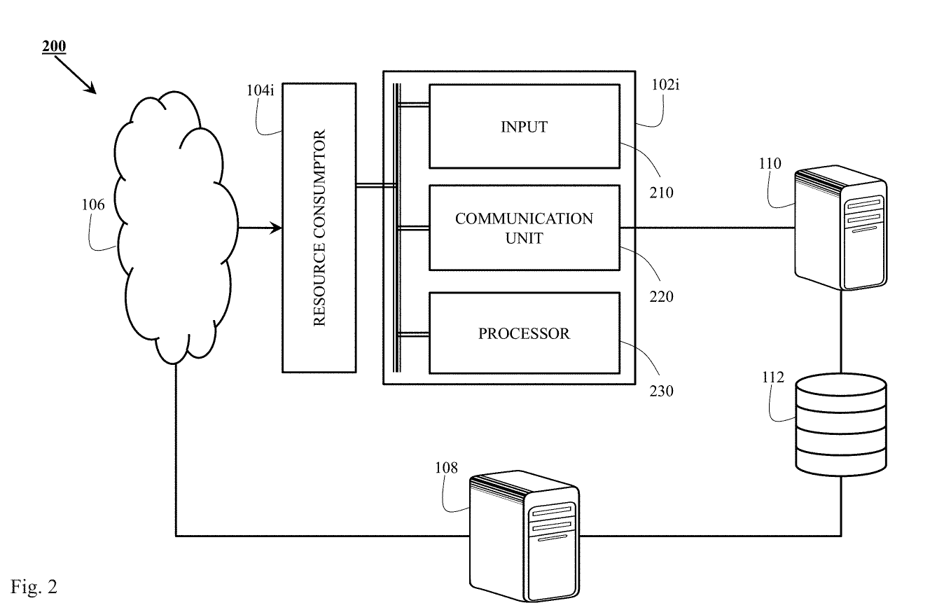

FIG. 2 illustrates a portion of the environment 100 involving a device 102i that is configured to negotiate with the resource allocation server 110, an optimized resource allocation. A value of the optimized resource allocation is denoted by xᵢ^{*}. The resource allocated to the device 102i by the resource allocation server 110 is optimized through a negotiation that takes place as an iterative process between the device 102i and the resource allocation server 110 and is carried out for a predetermined number (T) of iterations. The number (T) is chosen to be a fairly large number to ensure that resource allocation xᵢ(t) for an iteration t (where 0≤t≤T), converges towards an optimized resource allocation xᵢ^{*} as t approaches T. The value of the predetermined number (T) may be calculated or determined based on the type of application, or on the type of resource requested. In that manner, historical data, mathematical models, user behavior and computing capabilities of the devices and the servers involved may also be factored in during determination of the predetermined number (T).

The device 102i comprises an input 210 (for example, a touchscreen, a keyboard, a keypad, an input port and the like), a communication unit 220 and a processor 230.

The input 210 may be implemented as an input port for communicating with an electronic device through wires or wirelessly. For example, the electronic device may be a vehicle control system storing driver's travel habits (distance, time, electric consumption, weather, etc.). Alternatively, the electronic device may be a smartphone storing a calendar, and/or executing an application for travel such as for example Google Maps™, Waze™, and/or any other application that can be used to schedule routes based on appointments stored in a calendar, traffic and/or weather information. The input 210 may alternatively be an entry system of a vehicle control system for user manual entries. In another alternative, the input 210 may be a keyboard having an output connected to an input port of the device for manually inputting the required resource and the time period by a user. The input 210 may comprise one or several of the previously described means used separately or concurrently for inputting the required resource and the time period for receiving the required resource. For example, a smartphone may be used to provide an upcoming departure time, traffic and weather information, while the vehicle control system may concurrently provide the current available resource, the capacity parameters for receiving the required resource, and any other parameter to assist in generating the utility function by the processor 230.

Depending on the type of resource which is negotiated, the required resource and the time period may take different form. For example, in the case of an EV, the required resource may be an amount of electricity required or a distance to be travelled by the EV, and the time period may correspond to when the EV is expected to start its journey.

A specific construction and configuration of the communication unit 220 may vary as per communication protocols used for communication with the remote resource allocation server 110. The communication unit 220 in that manner may be designed for wired communication such as Ethernet, USB and the like or for wireless communication such as through Wi-Fi, RF communication, GPRS, GSM and CDMA etc. The processor 230 may further be supported by a memory unit (not shown), that may be in-built with a motherboard, for storing instruction for implementation of the AIMD algorithm and the non-stochastic derivatives. The functions of the monitoring server 108 and the storage device 112 may continue to be the same as have been discussed above or may have additional functions specific to an implementation. The device 102i operates simultaneously and concurrently with the other devices 102a, 102b, 102c . . . 102n etc. that may have similar constructions if not identical. Further, the other devices 102 may operate in a similar manner regardless of any subtle differences in construction. To that end the operation of the device 102i in the discussion below also applies to the other devices 102 operating simultaneously and concurrently for optimizing the resource allocated to each and every device 102i.

Although not depicted, the device 102i may be part of an apparatus or system which uses the allocated resource, such as for example an EV, or a modem. Alternatively, the device 102 may be independent of the apparatus or system which uses the allocated resource, such as for example a software application that is downloaded and executed by an electronic device (for example a computer, a tablet or a smartphone) in communication with the apparatus or system using the allocated resource, and which negotiates the resource allocated to the apparatus or system on behalf of the apparatus or system with the resource allocation server 110.

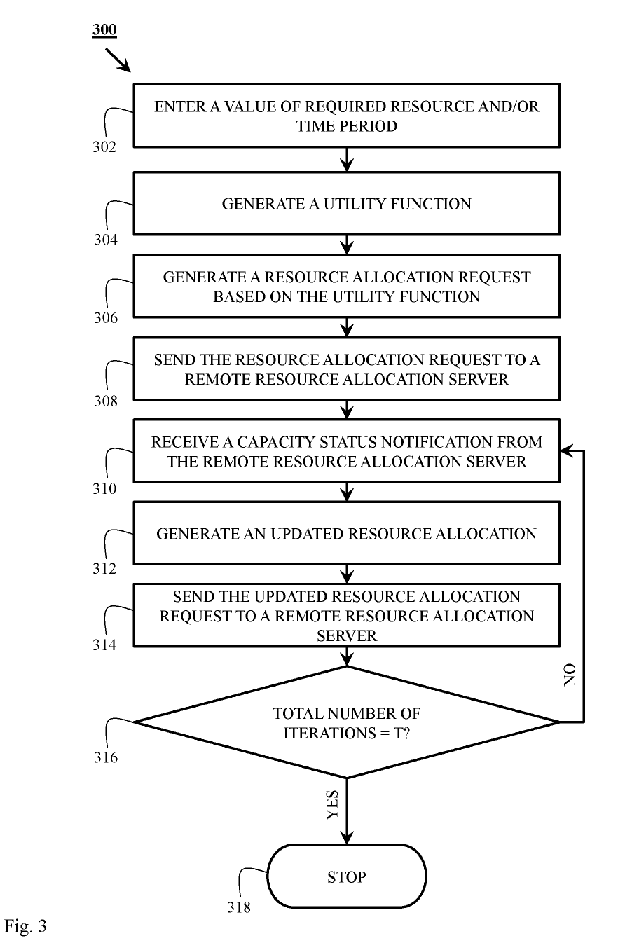

FIG. 3 illustrates a flowchart 300 depicting operation of the device 102i, in accordance with an embodiment of the present invention. At step 302, a value of the required resource is entered into the input 210. Additionally, a time period for receiving the required resource may also be entered into the input 210. The resource 106 in that manner may either may be available as a punctual quantity (for example liters of fuel, or kilograms of cooking gas or energy in kW-h), or a cumulative quantity over the time period.

At step 304, the processor 230 of the device 102i generates a utility function for the required resource. The utility function factors in the time period for obtaining the required resource. The utility function determines the amount of satisfaction obtained for various resource allocations. The utility function generated by the processor 230 is one of an increasing concave utility function, a quasi-concave utility function or a non-monotonic concave utility function.

Furthermore, the utility function may be a continuous function generated by the processor 230 based on different parameters. For example, when the processor 230 generates a utility function for required electricity by an Electric Vehicle (EV) plugged in to a charging station, the utility function generated by the processor 230 comprises at least the range that the EV is forecasting to travel and a maximum capacity for the batteries of the EV. The range that the EV is forecasting to travel and the maximum capacity of the batteries of the EV are used as inputs by the processor 230 to generate the utility function. The processor 230 may generate the utility function based on a built-in general function, or by selecting one of several built-in general functions which corresponds best to the required resource and the time period for obtaining the requested resource. As each EV charges at a different speed, requires different electricity levels for travelling a predetermined distance, the processor 230 of each device 102i may comprise a customized built-in general function or a library of customized built-in general functions taking into consideration the particularities of each EV.

In generating the utility function by the processor 230 of the device 102i, the time period may or may not play an important role, or at least may affect the utility derived from the resource allocation. For example, a certain N kW-h of energy (the allocated resource) is required from an EV charging station, for charging a vehicle travelling from a city ‘A’ to city ‘B’, and the time period allocated for accumulated the certain N kW-h of energy is limited.

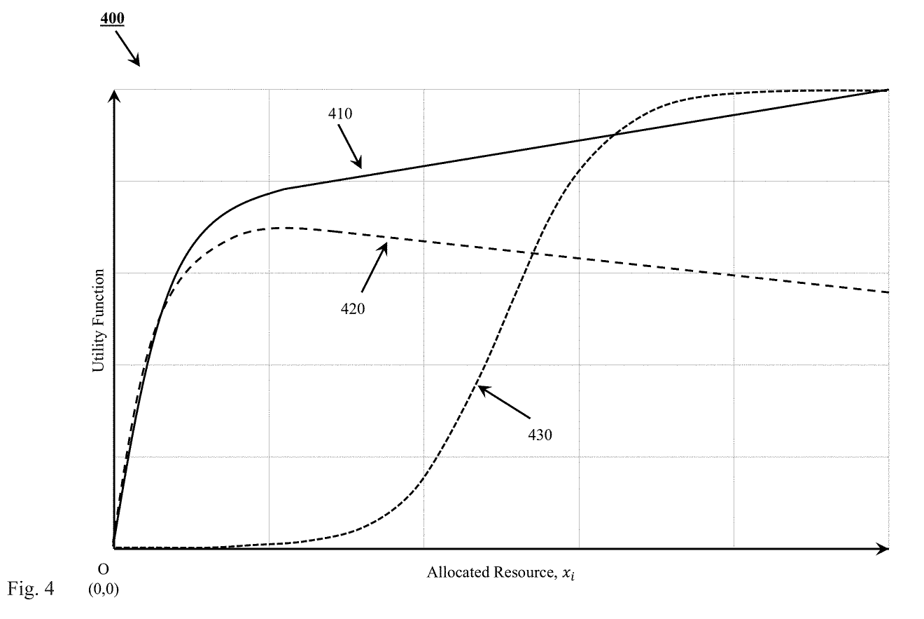

FIG. 4 illustrates a plurality of examples of utility functions in relation to values of allocated resource xᵢ. As illustrated in FIG. 4, a curve 410 graphically depicts an increasing concave utility function, a curve 420 depicts a non-monotonic concave utility function and a curve 430 depicts a quasi-concave utility function.

The rational for using the increasing concave utility function is an understanding that in certain scenarios the utility or the benefit that the device derives from an allocation increases continuously as the size of the allocation increases. One exemplary scenario where an increasing concave utility function may be highly applicable would be allocation of goods where the user does not have to pay for allocated resources. In case of non-payment, the user would always tend to have more and more without having to worry about how much they actually need the required resource. An example of the increasing concave utility function generated by the processor 230 is a normalized logarithmic function given by equation (2)

$${u}_{i} ( {x}_{i} ) = 100 \frac{log ( 1 + {η}_{i} {x}_{i} )}{log ( 1 + {η}_{i} {χ}_{i} )} \qquad ( 2 )$$

χᵢ denotes amount of resource allocated that gives 100 units of utility to the device i. Moreover, in the lack of resource the utility function value is zero. So, the normalized logarithmic utility function satisfies uᵢ(0)=0 and uᵢ(χᵢ)=100. The parameter II indicates how urgently the required resource is needed by effecting on the rate of utility percentage that is a function of allocated resource xᵢ. Values of χᵢ and ηᵢ may be calculated by using historical data, user behaviour, projected demands, the time period entered and other factors depending upon specific application or implementation of the present invention.

The non-monotonic concave utility function may be applicable in case of allocation of subsidized goods, such as electricity, where a fee per use is shared with an entire population. For example, if the device i is charged a constant price L per unit of the received resource xᵢ, a utility function vᵢ may be given as uᵢ minus the overall cost if xᵢ were to be allocated. vᵢ is given by equation (3).

$${v}_{i} ( {x}_{i} ) = {u}_{i} ( {x}_{i} ) - {Lx}_{i} = 100 \frac{log ( 1 + {η}_{i} {x}_{i} )}{log ( 1 + {η}_{i} {χ}_{i} )} - {Lx}_{i} \qquad ( 3 )$$

For the reason of factoring of the cost, the payoff function vᵢ will not always be an increasing function, hence the term ‘non-monotonic’ and has been depicted in FIG. 4 as the curve 420. In such a scenario, another objective of the present invention can be given as equation (4).

maximizeΣⱼ₌₁ⁿvⱼ(xⱼ), while Σⱼ₌₁ⁿ(xⱼ)≤C (4)

An example of the quasi-concave utility function is a sigmoidal function. The sigmoidal utility function, denoted by the curve 430 in FIG. 4, is an increasing function with an inflection point and is convex for allocated resource below the inflection point and is concave for allocated resource above the inflection point. The rationale behind the sigmoidal utility function is that low values of allocated resource offer very low increase in degree of satisfaction. As the allocated resource continues, satisfaction increases rapidly until a point where saturation appears and remains sharp after it. Satisfaction again increase slowly when allocated resource continues toward far away saturation point. One example for this kind of scenario is where the device needs minimum N kW-h of electrical energy to get to the city ‘B’ from city ‘A’. Any value of the resource allocation that is less than N offers no real utility to the device, however, once N kW-h of electrical energy has been stored in the car batteries any further charge will not offer any significant benefit either. A sigmoidal utility function wᵢ may be represented as equation (5).

$${w}_{i} ( {x}_{i} ) = \frac{100}{1 + {e}^{- {η}_{i} ( {x}_{i} - {ψ}_{i} )}} - \frac{100}{1 + {e}^{{η}_{i} {ψ}_{i}}} \qquad ( 5 )$$

Here ηᵢ is the steepness of the curve that indicates how the required resource is needed urgently for each device i. The parameter ψᵢ denotes the inflection point of the function that when achieved satisfies the urgent need of device i for the resource 106. The function satisfies wᵢ(0)=0 and wᵢ(xᵢ)=100 as xᵢ tends to infinity.

At step 306, the processor 230 generates a resource allocation request based on the utility function generated by the processor 230. As we have discussed above that the optimized resource allocation is achieved after a number (T) of iterations, the resource allocation request basically initializes xᵢ for the first iteration. For an iteration t, the resource allocation may be denoted as xᵢ(t), (where t=0, 2, 3, . . . 7). So essentially, the resource allocation request assigns a number or a matrix to xᵢ(0). In that manner, depending upon specific implementations, xᵢ(0) may be the value of the required resource itself, or the value and the time period in form of a matrix, or xᵢ(0) may also be the value of the required resource divided by the time period or a product of the value of the required resource and the time period. Alternatively, xᵢ(0) may correspond to the initial resource allocation received by the device 102i.

At step 308, the processor 230 sends the resource allocation request to the remote resource allocation server 110, through the communication unit 220. As discussed above, the remote resource allocation server 110 is in communication with the storage device 112 that is configured to store the state of the resource 106.

At step 310, in response to the resource allocation request the processor 230 receives through the communication unit 220 a capacity status notification for the required resource from the remote resource allocation server 110. The capacity status notification for the iteration t may be represented as sᵢ(t) and indicates the state of the resource 106 to the processor 230.

At step 312, the processor 230 generates an updated resource allocation request. In that manner, the updated resource allocation request is generated based on the generated utility function, the Additive Increase Multiplicative Decrease (AIMD) algorithm and the required resource capacity status. The AIMD algorithm here is envisaged to include both stochastic and non-stochastic derivatives of the AIMD algorithm as well. To that end, the updated resource allocation request is any of the following: an increase request of the required resource, a decrease request of the required resource or a no-change request of the required resource.

The increase request is factored in when the capacity status notification indicates the resource 106 has not entirely been allocated. In that manner, in several embodiments, the updated resource allocation request is calculated by adding a growth factor to the previous resource allocation request. Growth factor is identical for all devices and theoretically can be feasible as a positive real number smaller than the capacity constraint C, however the value of the growth factor may be implementation dependent and empirically determined. The decrease request is factored in when the capacity status notification received indicates that the resource 106 is already fully allocated or over allocated. In that manner, in several embodiments, the updated resource allocation request is calculated by multiplying the previous resource allocation request with a drop factor. Drop factor, also, is identical for all devices and theoretically can be chosen any positive real number greater than 0 and smaller than one, however the Value of the drop factor may be implementation dependent and empirically determined.

If the negotiation for the optimized allocation precedes actual consumption of the resource 106, the resource 106 actually starts getting consumed when optimized allocation has been achieved for all the competing n devices. In a scenario where there is already a consumption of the resource 106 being carried out, such as in a scenario where there are already m EVs are plugged in to a charging station, addition of another EV will make n=m+1, the negotiations may begin again where all m+1 devices 102 would renegotiate their optimized allocations and the resource 106 will be delivered to the m+1 EVs in accordance with the renegotiated optimized allocations. The act of delivery of the electrical power to the m EVs as per previous optimized allocations may or may not be halted during the process of renegotiation. However, the distributed approach of the present invention would allow the negotiations to be carried out in a relatively short period of time making the reallocation as good as seamless.

At step 314, the processor 230 sends the updated resource allocation request to the remote resource allocation server 110. At step 316, the processor 230 checks if the total number of iterations have equaled the predetermined number (T) of iterations.

If yes, the allocation achieved at the end of the predetermined number (1) of iterations is the optimal allocation xᵢ^{*}. Otherwise, the processor 230 returns to step 310 where the processor 230 again receives the capacity status notification from the remote resource allocation server 110. The processor 230 in that manner, iteratively repeats sending the updated resource allocation request through the communication unit 220 to the remote resource allocation server 110, receiving, through the communication unit 220, the required resource capacity status from the remote resource allocation server 110 and generating the updated resource allocation request until the updated resource allocation request converges with the optimal allocation xᵢ^{*}.

The generation of the updated resource allocation request, sending to the remote resource allocation server 110 and achievement of the convergence will vary as per the utility function and the derivative of AIMD algorithm implemented. Several alternative approaches have been illustrated by means of several illustrations below and dependence upon a number of factors and parameters that have been introduced in the following discussion.

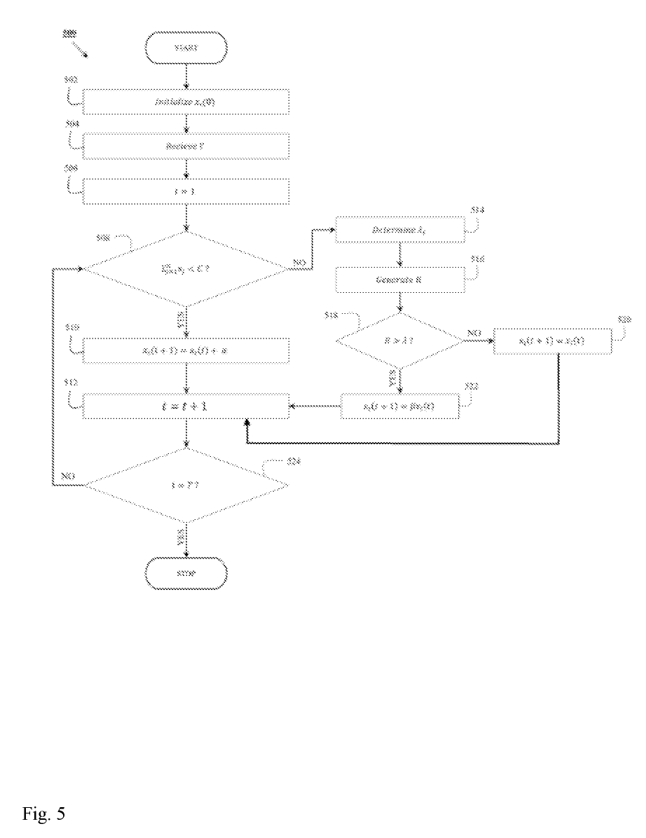

FIG. 5 illustrates an implementation 500 of a stochastic state dependent derivative of the AIMD algorithm, when the utility function is an increasing concave utility function, in accordance with an embodiment of the present invention. In case the AIMD algorithm is the stochastic state dependent algorithm, in AI phase the updated resource allocation request is calculated by adding a growth factor α (where, 0≤α≤C) to the previous resource allocation request xᵢ(t−1), while Σⱼ₌₁ⁿ (xⱼ)≤C. When the capacity limit has been violated, i.e, Eⱼ₌₁ⁿ(xⱼ)>C, the devices 102 are notified to execute the MD phase and the updated resource allocation request is calculated by multiplying the previous resource allocation request to a drop factor β (where, 0≤β≤1) to form the updated resource allocation request xᵢ(t). Further, the processor 230 may calculate from a probability λᵢ for the drop factor.

The probability λᵢ at t-th iteration, for each device i, depends on the long-term average allocated resource x̅ᵢ(t) through the equation (6).

$${λ}_{i} ( {\overline{x}}_{i} ( t ) ) = Γ \frac{{u}_{i}^{′} ( {\overline{x}}_{i} ( t ) )}{( {\overline{x}}_{i} ( t ) )} \qquad ( 6 )$$

Here, the parameter Γ is chosen to ensure that 0<λᵢ(xᵢ)<1. Additionally, the parameter Γ depends on the worst utility function that is independent of number of devices. It must be communicated to all the devices 102 by the remote resource allocation server 110.

Referring to FIG. 5, at step 502, the processor 230 initializes xᵢ(0), similar to step 306. At step 504, the processor receives the parameter Γ from the remote resource allocation server 110. At step 506, the first iteration is performed and t is assigned a value of one. At step 508, the remote resource allocation server 110 checks for the condition Σⱼ₌₁ⁿ (xⱼ)<C, if true, on receiving the capacity status notification, the processor 230 adds the growth factor α to the previous resource allocation request at step 510, as given in equation (7).

x₁(t+1)=xᵢ(t)+α (7)

However, if the condition of step 508, returns a false, then on receiving the capacity status notification, the processor 230 calculates the probability A, at step 514. At step 516, the processor 230 generates a random number R and checks a condition of R being greater than A, at step 518. If true, the processor 230 calculates the updated resource allocation request by multiplying the previous allocated resource to the drop factor β in step 522, as given in equation (8).

x₁(t+1)=βxᵢ(t) (8)

If the condition of step 518 returns false, the updated resource allocation request has no change from the previous request, at step 520, as given in equation (9).

xᵢ(t+1)=xᵢ(t) (9)

In any case the value of t is incremented by one at step 512, that may follow any one of steps 510, 520 or 522. At step 524, the processor 230 checks if the predetermined number of iterations have been performed or not. If true, xᵢ(T) is the optimized resource allocation xᵢ^{*}, else the implementation is returned to step 508 and the processor 230 again receives the capacity status notification from the remote resource allocation server 110.

In that manner, the processor 230 verifies that the updated resource allocation request is not greater than what would be the optimized resource allocation for the required resource, and reduces, with the probability λᵢ, the updated resource allocation request to the value of the optimized resource allocation, if the updated resource allocation request is greater than the optimized resource allocation for the required resource and the capacity constraint indicates that the resource 106 is already fully allocated. The same discussion of FIG. 5 can be extended to deterministic AIMD algorithms with subtle changes.

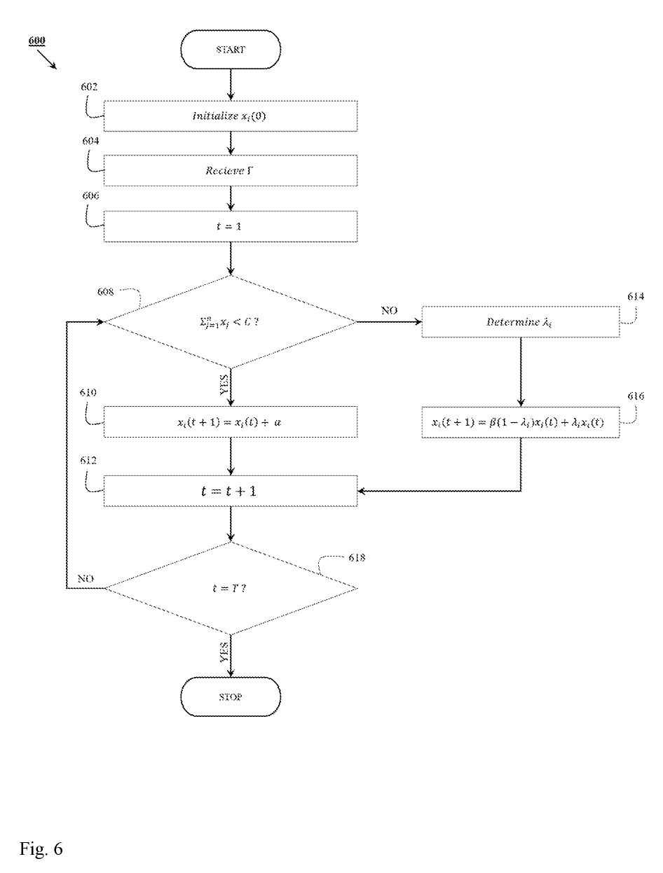

FIG. 6 illustrates an implementation 600 of a deterministic AIMD (DAIMD) algorithm, when the utility function is an increasing concave utility function, in accordance with an embodiment of the present invention. FIG. 6 illustrates that the strong convergence of derivative of utility function of long-term average allocated resource uᵢ^{′}(x̅ᵢ(t)), can be used to allocate resource optimally. In that regards, at step 602, the processor 230 initializes xᵢ(0), similar to step 306. At step 604, the processor receives the parameter Γ from the remote resource allocation server 110. At step 606, the first iteration is performed and t is assigned a value of one. At step 608, the remote resource allocation server 110 checks for the condition Σⱼ₌₁ⁿ(xⱼ)<C, if true, on receiving the capacity status notification, the processor 230 adds the growth factor α to the previous resource allocation request at step 610, as given in equation (7).

However, if the condition of step 608, returns a false, then on receiving the capacity status notification, the processor 230 calculates the probability A, at step 614. At step 616, the processor 230 calculates the updated resource allocation request on basis of the probability A, and the drop factor β, as given by equation (10).

x₁(t+1)=β(1−λᵢ)xᵢ(t)+λᵢxᵢ(t) (10)

In any case the value of t is incremented by one at step 612, that may follow any one of steps 610 and 616. At step 618, the processor 230 checks if the predetermined number of iterations have been performed or not. If true, xᵢ(T) is optimal resource allocation xᵢ^{*}, else the implementation 600 is returned to step 608 and the processor 230 again receives the capacity status notification from the remote resource allocation server 110. While implementations 500 and 600 are applicable for increasing concave utility functions they may or may not be applicable to the non-monotonic utility function vᵢ. This is due to the fact that in the case of the non-monotonic nature of the utility function vᵢ (referring to equation 3), from a specific point the allocation of resources not only does not increase the utility but also decrease it.

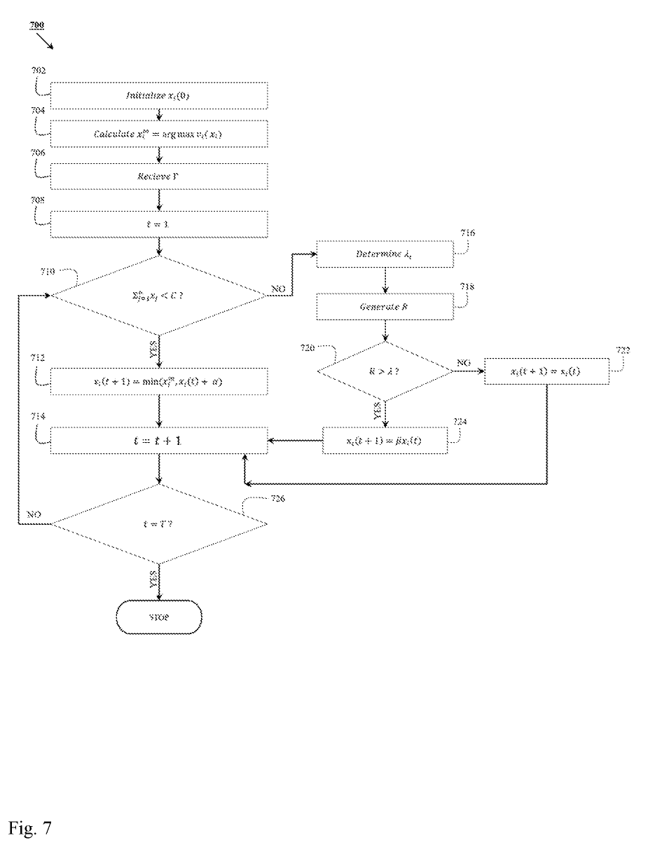

FIG. 7 illustrates an implementation 700 of a probabilistic AIMD (PAIMD) algorithm, when the utility function is a non-monotonic concave utility function, in accordance with an embodiment of the present invention. The specific point discussed above can be regarded as the point of maximum utility xᵢ^{m} and may calculated by the processor 230 internally at the device 102i. The probability λᵢ at t-th iteration for the implementation 700, for each device i, depends on the long-term average allocated resource (t) through the equation (11).

$${λ}_{i} ( {\overline{x}}_{i} ( t ) ) = Γ \frac{{v}_{i}^{′} ( {\overline{x}}_{i} ( t ) )}{( {\overline{x}}_{i} ( t ) )} \qquad ( 11 )$$

Referring to FIG. 7, at step 702, the processor 230 initializes xᵢ(0), similar to step 306. At step 704, the processor 230 calculates the point of maximum utility xᵢ^{m}, as described in equation (12).

xᵢ^{m}=arg max vᵢ(xᵢ) (12)

At step 706, the processor receives the parameter Γ from the remote resource allocation server 110. At step 708, the first iteration is performed and variable t is assigned a value of one. At step 710, the remote resource allocation server 110 checks for the condition Σⱼ₌₁ⁿ(xⱼ)<C, if true, on receiving the capacity status notification, the processor 230 calculates the updated resource allocation request from a minimum of the point of maximum utility xᵢ^{m} and the sum of the previous resource allocation request and the growth factor α, at step 712. This has been described in equation (13)

xᵢ(t+1)=min(xᵢ^{m},xᵢ(t)+α) (13)

However, if the condition of step 710, returns a false, then on receiving the capacity status notification, the processor 230 calculates the probability λᵢ at step 716. At step 718, the processor 230 generates a random number R and checks a condition of R being greater than λᵢ at step 720. If true, the processor 230 calculates the updated resource allocation request by multiplying the previous allocated resource to the drop factor β in step 724, as given in equation (8).

If the condition of step 720 returns a false, the updated resource allocation request has no change from the previous resource allocation request, at step 722, as given in equation (9).

In any case the value of the variable t is incremented by one at step 714, that may follow any one of steps 712, 722 or 714. At step 726, the processor 230 checks if the predetermined number of iterations have been performed or not. If true, xᵢ(T) is optimal resource allocation xᵢ^{*}, else the implementation 700 is returned to step 710 and the processor 230 again receives the capacity status notification from the remote resource allocation server 110. The present invention may also be extended to the case of quasi-concave utility equation wᵢ (refer equation 4) and implementation of that has been discussed in the following discussion.

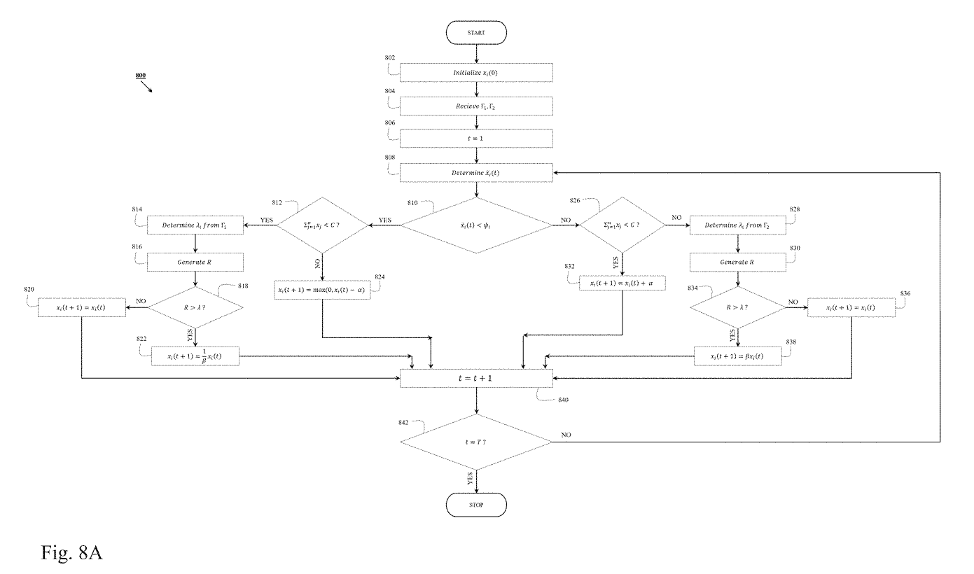

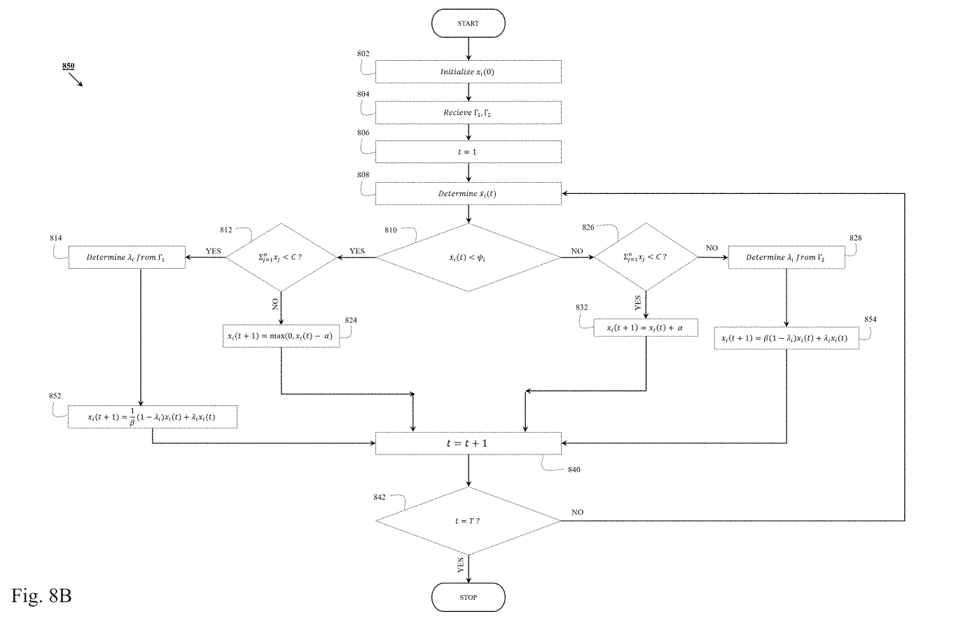

FIGS. 8A and 8B illustrate implementations 800 and 850 of quasi-derivatives of AIMD algorithm (QAIMD), when the utility function is a quasi-concave utility function, in accordance with an embodiment of the present invention. The key point is that in each iteration t, the long-term of allocated resource x̅ᵢ(t) is compared with the inflection point ψᵢ. If x̅ᵢ(t)<ψᵢ, the increase phase is built by multiplying the previous resource allocation request with a growth factor 1/β (where 1/β>1) with a probability A, that may be calculated from equation (14).

$${λ}_{i} ( {\overline{x}}_{i} ( t ) ) = {Γ}_{1} \frac{{w}_{i}^{′} ( {\overline{x}}_{i} ( t ) )}{( {\overline{x}}_{i} ( t ) )} \qquad ( 14 )$$

The decrease phase is made by subtracting a from the previous resource allocation request. However, x̅ᵢ(t)≥ψᵢ, approaches of implementations 500 and 600 are followed in partial. More clarity of partial inclusion of implementations 500 and 600 can be understood from specific descriptions of FIGS. 8A and 8B. Referring to FIG. 8A, at step 802, the processor 230 initializes xₜ(0), similar to step 306. At step 804, the processor receives parameters Γ₁ and Γ₂ from the remote resource allocation server 110. Γ₁ corresponds to x̅ᵢ(t)<ψᵢ and Γ₂ corresponds to x̅ᵢ(t) ψᵢ. At step 806, the first iteration is performed and t is assigned a value of one. At step 808, the processor 230 calculates x̅ᵢ(t). At step 810, the processor 230 checks for a condition x̅ᵢ(t)<ψᵢ. If the condition of step 810 returns a true, the implementation proceeds to step 812, where the remote resource allocation server 110 checks for the condition Σⱼ₌₁ⁿ(xⱼ)<C. If the condition of step 812 returns a false, on receiving the capacity status notification, the processor 230 subtracts the growth factor α from the previous resource allocation request at step 824, as given in equation (15).

xᵢ(t+1)=max(0,xᵢ(t)−α) (15)

However, if the condition of step 812, returns a true, then on receiving the capacity status notification, the processor 230 calculates the probability λᵢ at step 814 using equation (14). At step 816, the processor 230 generates a random number R and checks a condition of R being greater than λᵢ at step 818. If the condition of step 818 is true, the processor 230 calculates the updated resource allocation request by multiplying the previous allocated resource to 1/β in step 822, as given in equation (16).

$${x}_{i} ( t + 1 ) = \frac{1}{β} {x}_{i} ( t ) \qquad ( 16 )$$

If the condition of step 818 returns a false, the updated resource allocation request has no change from the previous resource allocation request, at step 820, as given in equation (9).

If the condition of the step 810 returns a false, the implementation proceeds to step 826. At step 826, the remote resource allocation server 110 checks for the condition Σⱼ₌₁ⁿ(xⱼ)<C, if true, on receiving the capacity status notification, the processor 230 adds the growth factor α to the previous resource allocation request at step 832, as given in equation (7).

However, if the condition of step 826, returns a false, then on receiving the capacity status notification, the processor 230 calculates the probability A, at step 828, using equation (17).

$${λ}_{i} ( {\overline{x}}_{i} ( t ) ) = {Γ}_{2} \frac{{w}_{i}^{′} ( {\overline{x}}_{i} ( t ) )}{( {\overline{x}}_{i} ( t ) )} \qquad ( 17 )$$

At step 830, the processor 230 generates a random number R and checks a condition of R being greater than λᵢ at step 834. If true, the processor 230 calculates the updated resource allocation request by multiplying the previous allocated resource to the drop factor β in step 838, as given in equation (8). If the condition of step 834 returns a false, the updated resource allocation request has no change from the previous request, at step 836, as given in equation (9).

In any case the value of t is incremented by one at step 840, that may follow any one of steps 820, 822, 824, 832, 836 and 838. At step 842, the processor 230 checks if the predetermined number (T) of iterations have been performed or not. If true, xᵢ(T) is optimal resource allocation xᵢ^{*}, else the implementation is returned to step 808 and the processor 230 again calculates x̅ᵢ(t).

Referring to FIG. 8B, the implementation 850 is quite similar to implementation 800, however, following step 814, the processor 230 calculates the updated resource allocation request from equation (18) at step 852.

$${x}_{i} ( t + 1 ) = \frac{1}{β} ( 1 - {λ}_{i} ) {x}_{i} ( t ) + {λ}_{i} {x}_{i} ( t ) \qquad ( 18 )$$

Similarly, following step 828, the implementation 850 proceeds to step 854 where the processor 230 calculates the updated resource allocation request using equation (10). Following steps 852 and step 854, the implementation 850 proceeds to step 840.

### Example 1

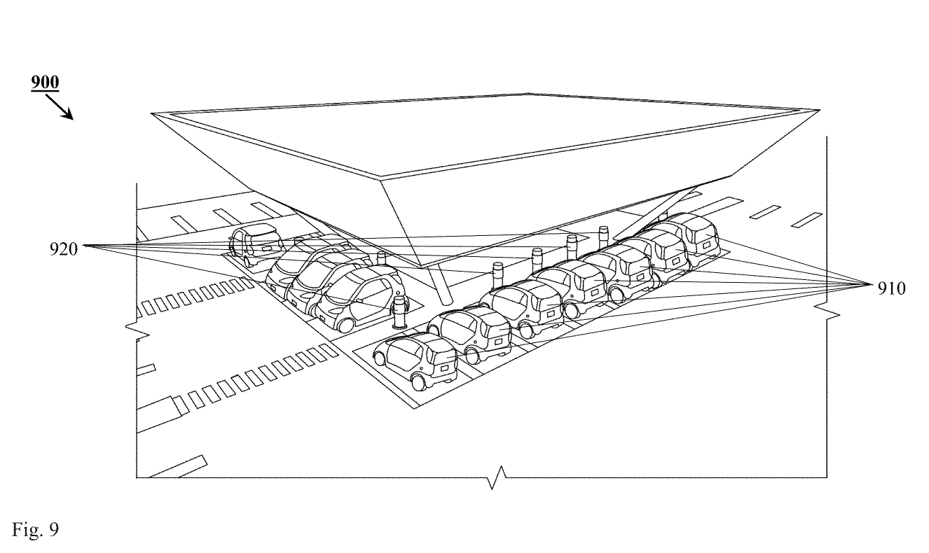

FIG. 9 illustrates an exemplary charging station 900 for EV, in accordance with an embodiment of the present invention. A plurality of EVs 910 (for example, 910a, 910b, 910c . . . 910n etc.) are plugged-in at several bays 920 within the charging station 900. The plurality of EVs 910 are envisaged to have the plurality of respective devices 102 (102a, 102b, 102c, . . . , 102n etc.) installed with the plurality of EVs 910 or installed in electronic devices in communication with the EVs 910. A plurality of charging setups (not shown) available with the plurality of EVs 910 act as the plurality of resource meters 104. In that manner, an EV 910i will have (directly or through an electronic device in communication therewith) the device 102i as discussed above.

This example demonstrates the efficiency and efficacy of the present invention in the context of a charging station of EVs. Power supplies of the charging station in that manner may be from a renewable energy source such as solar or wind and collectively have a constant capacity C in kW-h or a power grid. For the purpose of the example, the capacity C is adjusted to be 65% of the sum of all the utility functions of the devices when all the devices receive 100-unit satisfaction. The total number n of EVs is assigned a value of 50, where all the 50 EVs are plugged into the charging station 900 at the same time. Moreover, the growth factor α has been assigned a value of 1 and the drop factor β has been assigned a value of 0.85.

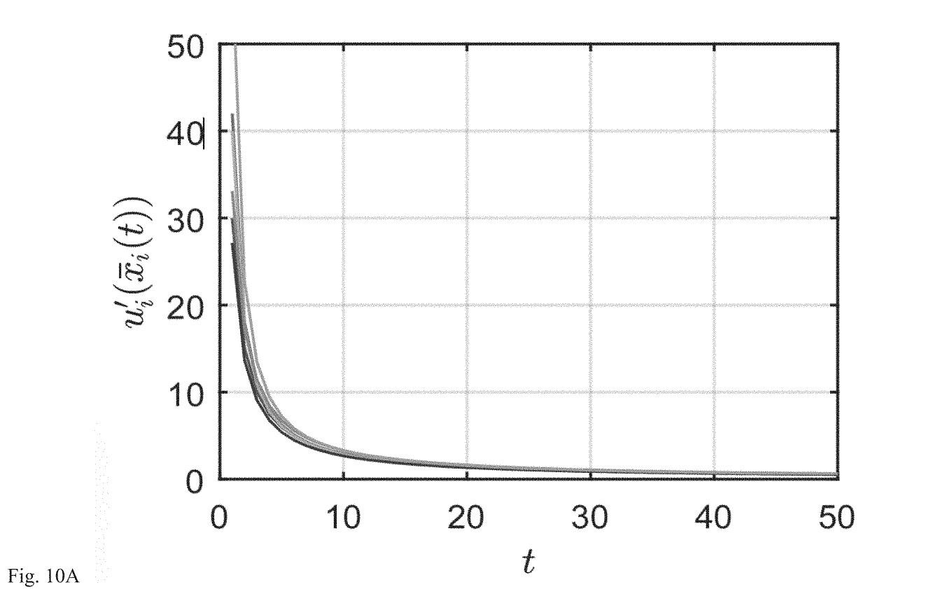

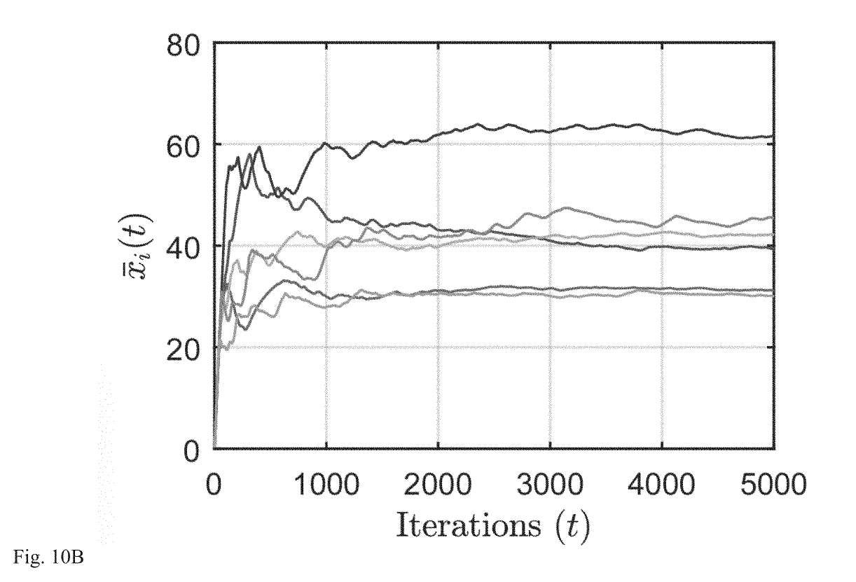

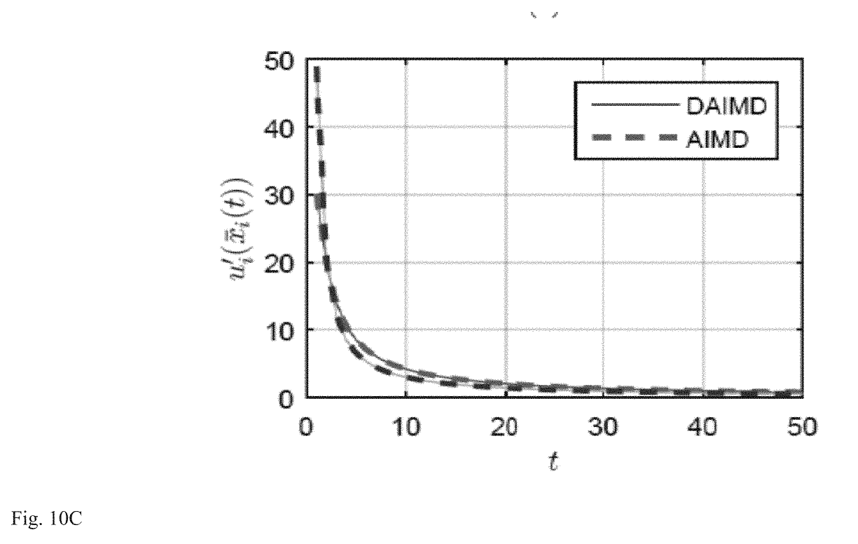

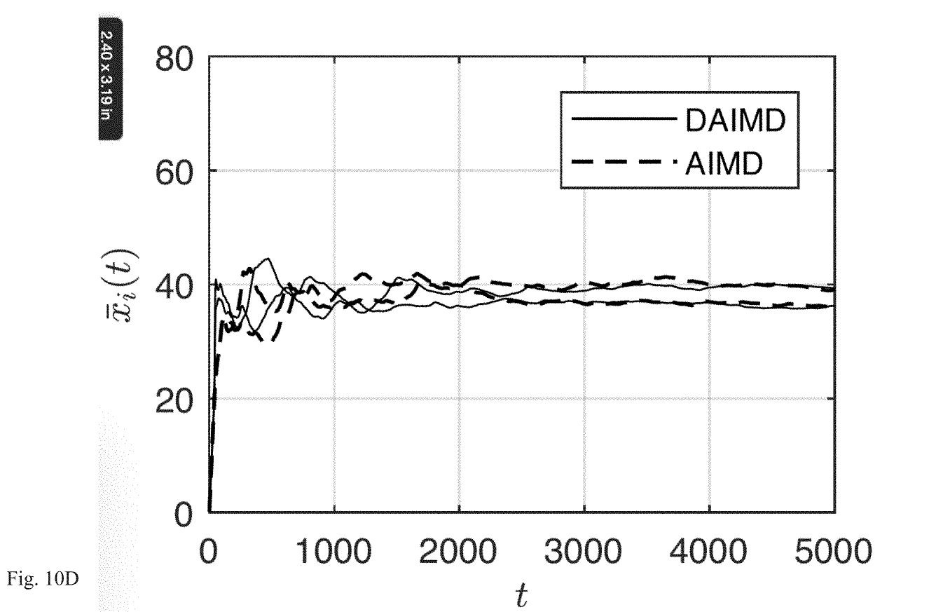

In a first scenario, the utility function of the EV 910i is chosen to be an increasing concave utility function and more specifically the normalized logarithmic utility function given by the equation (2). In that manner, the electrical power is regarded as a common good with no charging fee. χᵢ is chosen to be a random number within a range of (40, 60) and ηᵢ is chosen to be a random number within a range (0,1). The first scenario utilizes the DAIMD for the increasing concave utility function as illustrated in FIG. 6. FIGS. 10A-10D illustrate results obtained from simulation of the first scenario of this example.

FIG. 10A illustrates a rapid convergence for derivatives uᵢ^{′}(x̅ᵢ(t)) of the utility function when the value of the iteration t increases. FIG. 10B illustrates the value of long-term average state x̅ᵢ(t) for six randomly selected devices and shows each of them converge to a stable value that is xᵢ^{*}. FIG. 10C reveals the coincidence of deterministic and stochastic versions of derivative of the utility functions uᵢ^{′}(x̅ᵢ(t)). FIG. 10D also represents that deterministic and stochastic version of average state x̅ᵢ(t) fluctuates differently but the long-term averages for each device converge to the optimized resource allocation. Efficiencies of the DAIMD, calculated by Equation (19), in different runs are real numbers in the range of (0.97, 0.99).

$$efficiency = \frac{{lim}_{t \to ∞} {\sum }_{j = 1}^{n} {u}_{j} ( {x}_{j} ( t ) )}{{\sum }_{j = 1}^{n} {u}_{j} ( {x}_{j}^{*} )} \qquad ( 19 )$$

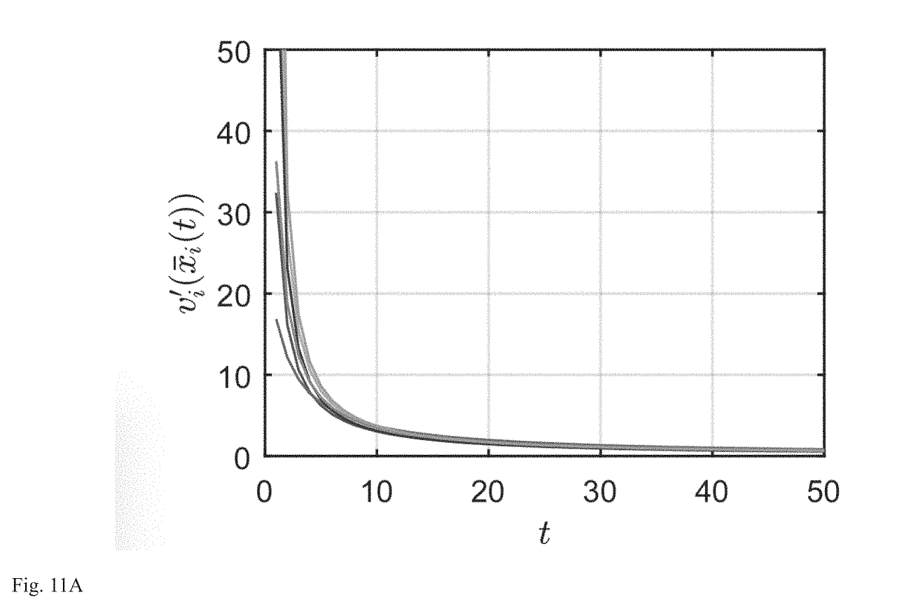

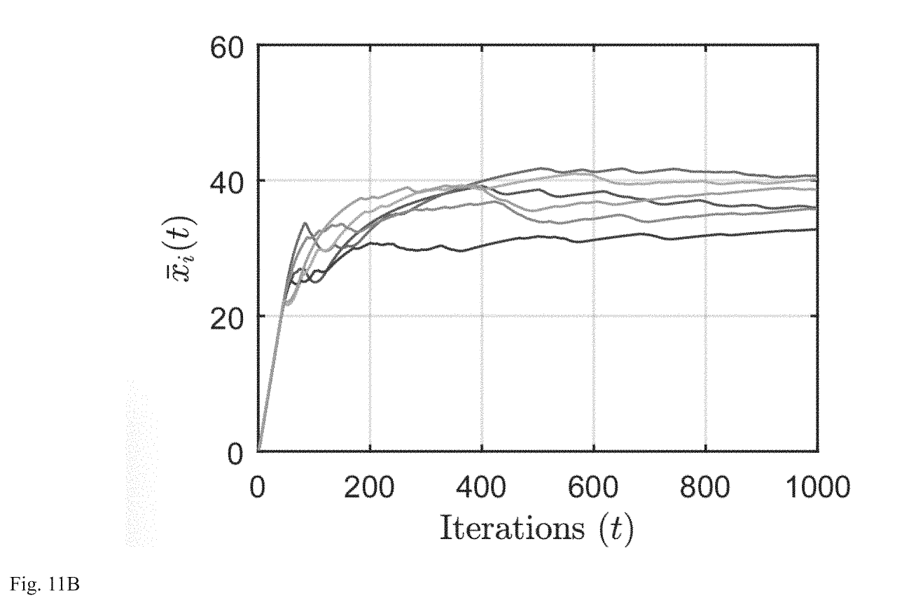

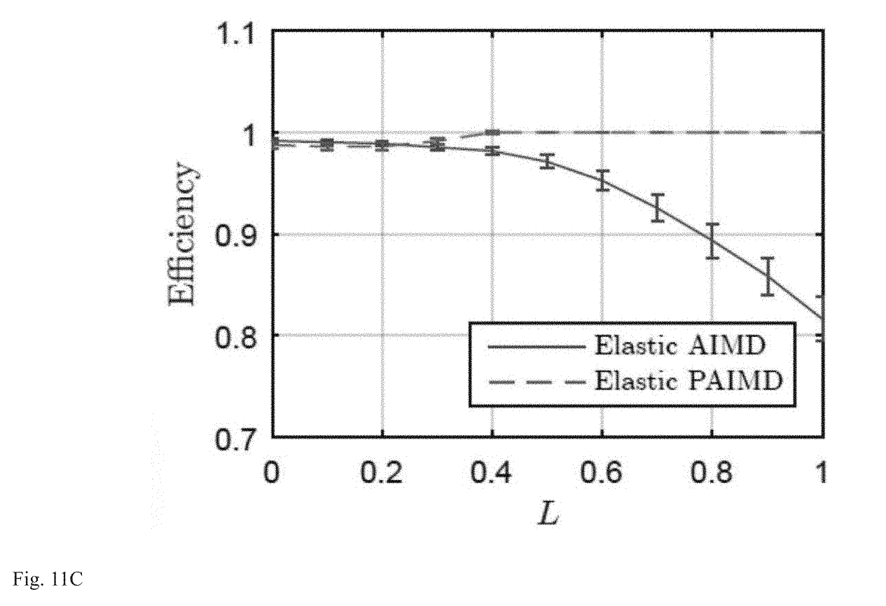

In a second scenario, the utility function of the EV 910i is chosen to be a non-monotonic concave utility function given by the equation (3). In that manner the electrical power is regarded as a subsidized resource. The second scenario utilizes the PAIMD for the non-monotonic concave utility function as illustrated in FIG. 7. The price per unit L is chosen from a set of {0.1, 0.2, 0.3 . . . 1}. FIGS. 11A-11C illustrate results obtained from simulation of the second scenario of this example. FIG. 11A illustrates a rapid convergence for derivatives vᵢ^{′}(x̅ᵢ(t)) of utility functions when iteration t increases. FIG. 11B illustrates the value of long-term average state x̅ᵢ(t) for six randomly selected devices and shows each of them converge to a stable value that is xᵢ^{*}. FIG. 11C illustrates efficiencies of the AIMD algorithm given by equation (19) and the PAIMD algorithm that is calculated by Equation (20).

$$efficiency = \frac{{lim}_{t \to ∞} {\sum }_{j = 1}^{n} {v}_{j} ( {x}_{j} ( t ) )}{{\sum }_{j = 1}^{n} {v}_{j} ( {x}_{j}^{*} )} \qquad ( 20 )$$

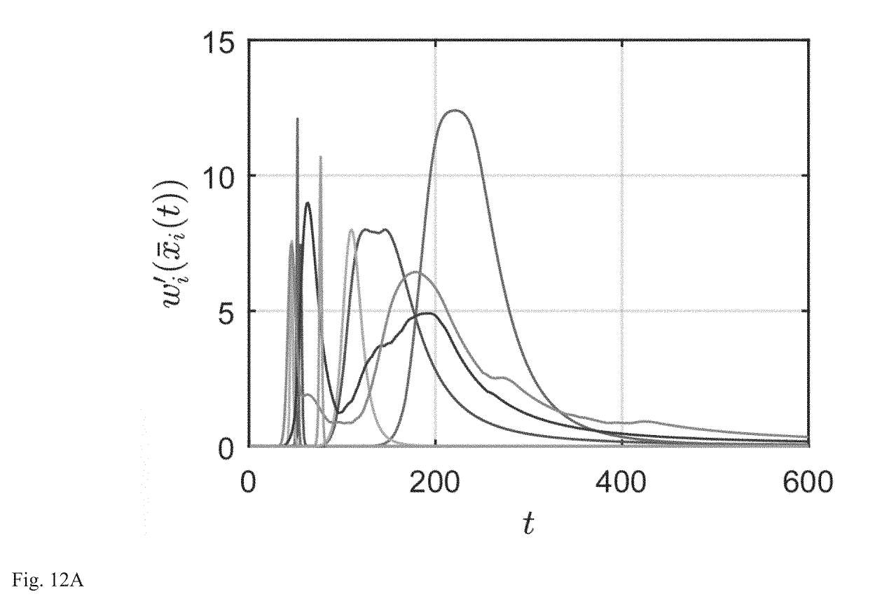

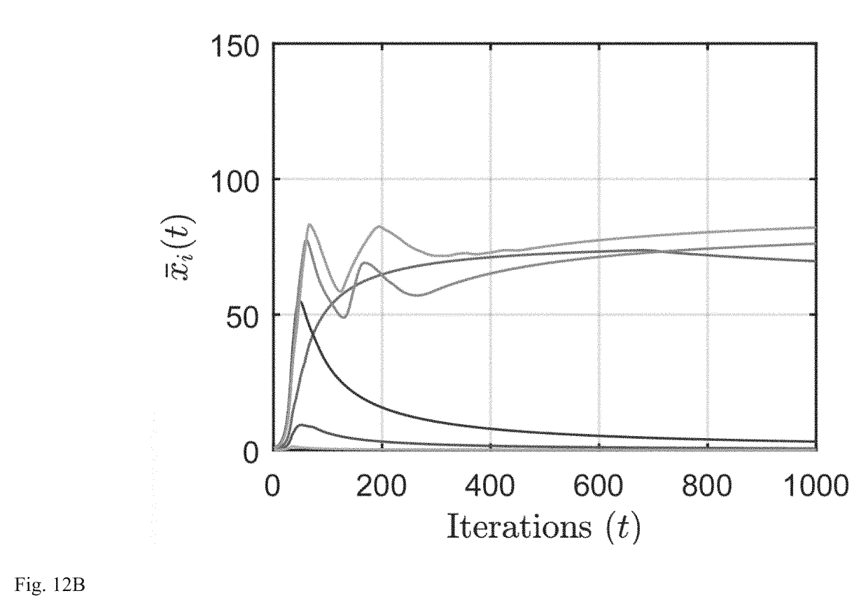

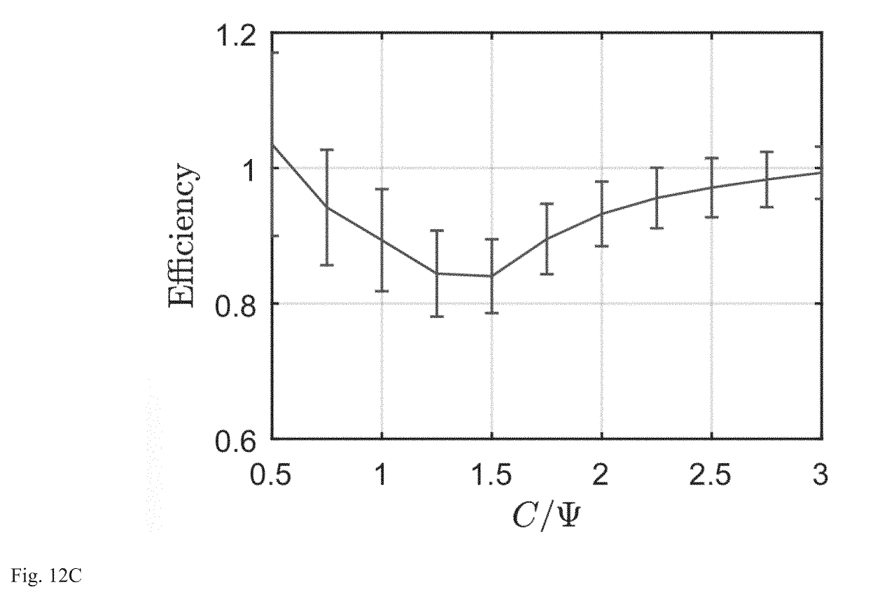

In a third scenario, the utility function of the EV 910i is chosen to be a quasi-concave utility function, such as the sigmoidal utility function given by the equation (5). The second scenario utilizes the derivatives of the AIMD algorithm illustrated in FIGS. 8A and 8B. ψᵢ is chosen to be a random number within a range of (25, 100) and ηᵢ is chosen to be a random number within a range (0, 25). FIGS. 12A-12C illustrate results obtained from simulation of the second scenario of this example. FIG. 12A illustrate the derivatives wᵢ^{′}(x̅ᵢ(t)) of utility functions for six randomly selected devices. FIG. 12A illustrates that the derivatives approach to zero as t increase but the convergence is slower than the derivatives vᵢ(x̅ᵢ(t)) of logarithmic utility function in FIG. 11A. FIG. 12B illustrates averages of allocated resource x̅ᵢ(t) for six randomly selected devices is displayed. Further, FIG. 12B illustrates x̅ᵢ(t) approach to a constant number that is the optimized resource allocation xᵢ^{*}.

FIG. 12C represents efficiency of the QAIMD algorithms, calculated by Equation (21), for different C/Ψ={0.5, 0.75, . . . , 3}, where Ψ=Σⱼ₌₁ⁿψⱼ.

$$efficiency = \frac{{lim}_{t \to ∞} {\sum }_{j = 1}^{n} {w}_{j} ( {x}_{j} ( t ) )}{{\sum }_{j = 1}^{n} {w}_{j} ( {x}_{j}^{*} )} \qquad ( 21 )$$

For each device i the QAIMD algorithm decides between increasing allocated resource or decreasing it toward zero. The efficiency of the QAIMD algorithm is better for small values of capacity constraint, but it decreases when capacity is around Ψ. The efficiency improves again when the capacity is large enough.

The present invention offers a number of advantages. For example, the distributed approach allows the privacy of the individual utility functions to be preserved. There is negligible communication overhead as the devices are not communicating amongst themselves. Moreover, since each device will handle their share of computational effort, there is hardly any load on a central authority such as the remote resource allocation server 110. Also, in the event of partial non-functioning of the central authority, the entire setup may still remain functional.

The features can be implemented in a computer system that includes a back-end component, such as a data server or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a LAN, a WAN and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an Application Programming Interface (API). An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some embodiments, an API call can report to an application the capabilities of a device running the application, such as input capability, output capability, processing capability, power capability, communications capability, etc.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publicly accessible network such as the Internet.

It should also be understood that, unless specifically stated otherwise as apparent from the following discussion, it is appreciated that throughout the description, discussions utilizing terms such as “controlling” or “obtaining” or “computing” or “storing” or “receiving” or “determining” or the like, refer to the action and processes of a computer system, or similar electronic computing device, that processes and transforms data represented as physical (electronic) quantities within the computer system's registers and memories into other data similarly represented as physical quantities within the computer⋅system memories or registers or other such information storage, transmission or display devices.

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

A number of embodiments have been described. Nevertheless, it will be understood that various modifications may be made. Elements of one or more embodiments may be combined, deleted, modified, or supplemented to form further embodiments. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A device for negotiating with a remote resource allocation server, an optimized resource allocation, the device comprising:
an input for entering a value of required resource and a time period for receiving the required resource;
a communication unit for communicating with the remote resource allocation server; and
a processor for:
generating a utility function for the required resource and time period, the generated utility function being one of the following: an increasing concave utility function, a quasi-concave utility function or a non-monotonic concave utility function, the utility function further defining an optimal allocation for the required resource;
generating a resource allocation request based on the utility function;
sending the resource allocation request through the communication unit to the remote resource allocation server;
receiving through the communication unit a capacity status notification for the required resource from the remote resource allocation server;
generating an updated resource allocation request based on: the utility function, an Additive Increase Multiplicative Decrease (AIMD) algorithm and the required resource capacity status; and
iteratively repeating sending the updated resource allocation request through the communication unit to the remote resource allocation server, receiving, through the communication unit, the required resource capacity status from the remote resource allocation server and generating the updated resource allocation request until the updated resource allocation request converges with the optimal allocation.

2. The device of claim 1, wherein the capacity status received is a capacity constraint indicating that the required resource is already fully allocated.

3. The device of claim 1, wherein the updated resource allocation request is any of the following: an increase request of the required resource, a decrease request of the required resource or a no-change request of the required resource.

4. The device of claim 1, wherein the updated resource allocation request is calculated by adding a growth factor to the previous resource allocation request.

5. The device of claim 1, wherein the updated resource allocation request is calculated by multiplying the previous resource allocation request with a drop factor.

6. The device of claim 5, wherein the processor calculates from a probability for the drop factor.

7. The device of claim 1, wherein the utility function generated by the processor is a normalized logarithmic function or Sigmoidal function.

8. The device of claim 1, wherein the processor further verifies that the updated resource allocation request is not greater than the optimal allocation for the required resource, and reduces, with a probability, the updated resource allocation request to the value of the optimal optical allocation if the updated resource allocation request is greater than the optimal allocation for the required resource and the capacity constraint indicates that the resource is already fully allocated.

9. The device of claim 1, wherein the input for entering the value of required resource and the time period for receiving the required resource is at least one of the following: an input port for receiving a message including the required resource and the time period for receiving the require resource from an electronic device, an input port for receiving a message including the required resource and the time period for receiving the require resource from a vehicle control system, an input port for receiving a message including the required resource and the time period for receiving the required resource from an electronic device storing a calendar; an input port for receiving a message including the required resource and the time period for receiving the required resource from an electronic device executing an application for travel, an input port for receiving a message including the required resource and the time period for receiving the required resource from an electronic device executing an application for forecasting traffic during travel, an input port for receiving a message including the required resource and the time period for receiving the required resource from a vehicle control system allowing manual entries by a user, and a keyboard for entering the required resource and the time period for receiving the required resource by a user.

10. An electric vehicle comprising:
a device for negotiating an optimized electric allocation, the device comprising:
an input for entering a value of required electricity and a time period for receiving the required electricity;
a communication unit for communicating with a remote electric charging allocation server; and
a processor for:
generating a utility function for the required electricity and time period, the generated utility function being one of the following: a concave utility function, a quasi-concave utility function or a non-monotonic utility function, the utility function defining an optimal allocation for the required electricity;
generating a resource allocation request based on the utility function;
sending the resource allocation request through the communication unit to the remote electric charging allocation server;
receiving through the communication unit an electrical capacity status from the remote electric charging server;
generating an updated resource allocation request based on: the utility function, an Additive Increase Multiplicative Decrease (AIMD) algorithm and the capacity status; and
iteratively repeating sending the updated resource allocation request through the communication unit to the remote electric charging allocation server, receiving through the communication unit the electrical capacity status from the remote electric charging allocation server and generating the updated resource allocation request until the update resource allocation request converges with the optimal allocation.

11. The electric vehicle of claim 10, wherein the capacity status received is a capacity constraint indicating that the electricity is already fully allocated.

12. The electric vehicle of claim 10, wherein the updated resource allocation request is any of the following: an increase request, a decrease request or a no-change request.

13. The electric vehicle of claim 10, wherein the updated resource allocation request is calculated by adding a growth factor to the previous updated resource allocation.

14. The electric vehicle of claim 10, wherein the updated resource allocation request is calculated by multiplying the previous resource allocation request to a drop factor.

15. The electric vehicle of claim 10, where the processor calculates from a probability for the drop factor.

16. The electric vehicle of claim 10, wherein the utility function generated by the processor is a normalized logarithmic function.

17. The electric vehicle of claim 10, wherein the processor further verifies that the updated resource allocation request is not greater than the optimal allocation, and reduces, with a probability, the updated resource allocation request to the value of the optimal optical allocation if the updated resource allocation request is greater than the optimal allocation and the capacity constraint indicates that the electricity is already fully allocated.

18. The electric vehicle of claim 10, wherein the input for entering the value for the required electricity and the time period for receiving the required electricity is at least one of the following: an input port for receiving a message including the required electricity and the time period for receiving the required electricity from an electronic device, an input port for receiving a message including the required electricity and the time period for receiving the require electricity from a vehicle control system, an input port for receiving a message including the value of required electricity and the time period for receiving the required electricity from an electronic device storing a calendar; an input port for receiving a message including the value of required electricity and the time period for receiving the required electricity from an electronic device executing an application for travel, an input port for receiving a message including the value of required electricity and the time period for receiving the required electricity from an electronic device executing an application for forecasting traffic during travel, an input port for receiving a message including the value of required electricity and the time period for receiving the required electricity from a vehicle control system of a manual entries performed by a user of the vehicle control system, a keyboard for entering the required electricity and the time period for receiving the required electricity by a user.
